(19) United States
(12) Patent Application Publication
(10) Pub. No.: US 2014/0137208 A1
(43) Pub. Date: May 15, 2014

(54) MOBILE COMPUTING DEVICE-BASED SECURE BRIEFING SYSTEM

(71) Applicant: EXECUTIVE BRIEFING BOOK COMPANY, LLC, Leesburg, VA (US)

(72) Inventors: Douglas Scott Harts, Sterling, VA (US); Daniel John Ryan, Ashburn, VA (US); Stephen Patrick Dvoranchik, Herndon, VA (US); Jerome Lorenzo Haynesworth, Leesburg, VA (US)

(73) Assignee: EXECUTIVE BRIEFING BOOK COMPANY, LLC, Leesburg, VA (US)

(21) Appl. No.: 14/080,344

(22) Filed: Nov. 14, 2013

Related U.S. Application Data
(60) Provisional application No. 61/726,398, filed on Nov. 14, 2012.

(51) Int. Cl. H04L 29/06

(52) U.S. Cl. CPC H04L 63/10
USPC 726/4

(57) ABSTRACT

Systems, methods and computer program products that: convert hard-copy, text-based report delivery mechanism into digital delivery application with modern user interface functionality; provide a secure, reliable back-end infrastructure for report assembly and dissemination within a classified network; and integrate interactive multi-media content and technologies, including real-time interactive content and communication, are disclosed. In an aspect, secure briefs customized for multiple individuals within an entity are created. Such secure briefs replace traditional physical briefing books and are accessible via a secure mobile computing device, such as a tablet computer.

### CROSS-REFERENCE TO RELATED APPLICATION

This application claims the benefit of U.S. Provisional Patent Application No. 61/726,398, filed Nov. 14, 2012, and entitled “Executive Briefing Book”, the entire contents of which is incorporated herein by reference.

### FIELD OF THE DISCLOSURE

The present disclosure generally relates to information security and more particularly providing secure briefings electronic devices.

### BACKGROUND

It is common for leaders, especially in U.S. federal government's leadership, to employ a manual process to create hard copy briefing books for dissemination during daily briefings. For example, the President's Daily Brief (PDB) is a collection of 6-10 headlines, which make up a 10-15 page document, which is hand delivered to the President and a handful of advisors, separately or together. It usually is viewed by around 20 people a day A CIA briefer travels to the recipient's home or office and waits for him or her to read the brief. It is then collected by the CIA briefer and locked in a vault in the CIA headquarters.

Generally speaking, briefing book users, including top executive leaders, receive binders with printed internal and external intelligence reporting, as well as related supporting materials. The content of these binders is used to drive briefings and connected discussions each work day, and are ultimately used to take action based on the disseminated content.

The above-described manual process is error-prone but has been around for decades. Federal agencies and other entities who utilize briefing books, however, would like to replace this labor-intensive manual process with an enhanced electronic system. Such a system may provide a secure digital or web environment and a touch- or digital ink-enabled interface.

What is needed are systems, methods, and computer program products which supplant the current printed process, including editing and arranging intelligence and other types of reports into daily briefings, securely distributing content, and tracking annotations for specific users to comply with entity-specific security requirements (e.g., congressional mandates). Further, new features such as the incorporation of audio and video content, consumption using secure tablet, PDA, notebook and other mobile computing devices, and usage auditing are also needed.

### SUMMARY

This Summary is provided to introduce a selection of concepts in a simplified form that are further described below in the Detailed Description. This Summary is not intended to identify key features or essential features of the subject matter to be claimed, nor is it intended to be used to limit the scope of the subject matter to be claimed.

The present disclosure meets the above-identified needs by providing systems, methods and computer program products that: convert hard-copy, text-based report delivery mechanism into digital delivery application with modern user interface functionality; provide a secure, reliable back-end infrastructure for report assembly and dissemination within a classified network; and integrate interactive multi-media content and technologies, including real-time interactive content and communications.

In an aspect, the present disclosure provides tools for facilitating the creation and dissemination of electronic executive briefing books that combine touch-enabled hardware devices with secure encryption of data at rest, served from a secure back-end data repository, delivered in a data-efficient stream-lined manner with persistent session management suitable for wireless connections in low bandwidth conditions and presented on mobile devices with inter-report keyword/search-enabled linking and embedded audio, video, and geo-spatial supporting information, which can be re-arranged on the fly on the mobile device by agency, topic, keyword, and date.

In an aspect of the present disclosure, entities (e.g., a federal agency, White House staff) may replace the process or curating and producing static, printed briefing books and other materials for executive decision makers. The present disclosure represents a significant efficiency improvement because manual assembly and distribution of briefing books is both time and resource intensive. The present disclosure provides a more efficient process of briefing book assembly and linking of related materials for end user consumption and a more efficient method of distributing content to appropriate audiences. The present disclosure adds a secure content tracking process for control of sensitive data.

By converting a manual, paper-based intelligence briefing book process to an electronic system, entities may better prepare executives for briefings with more interactive content, provide more up to date content and analysis, and enhance situational awareness with appropriate role-based security trimming for a broader audience of briefing consumers. That is, a single master electronic briefing book or report may be prepared and all or only portions of the book may be displayed to a briefing consumer, based on information about the briefing consumer such as clearance level, involvement in a given project or area, and the like.

In an aspect of the present disclosure a robust, maintainable and secure mission-critical daily intelligence dissemination system is delivered to users. The system provides a visually-appealing, intuitive tablet-based interface for executives and an enhanced web interface for producers and consumers of classified intelligence reports.

Various aspects of the present disclosure reduce the need for printed copies of daily intelligence briefings while enhancing content with multimedia content including photos, voice recordings, and video. Users with a tablet computing device (or laptop, notebook, personal digital assistant (PDA), mobile telephone, smart telephone, or like devices) are able to access reports. In an aspect, the user may add handwritten notes to the reports and store these notes with the content, as well as export handwritten notes for offsite record keeping.

In an aspect, users of the systems, methods and computer program products of the present disclosure may include a director and executive staff of one or more federal agencies who read and act on intelligence reports daily. The director and executive staff receive specific sets of priority intelligence reports on assigned mobile tablet computing devices. Additional users can access the daily briefing reports via a web interface. Intelligence support personnel are responsible for editing and publishing each daily briefing as well as maintaining the security of each report item, and they will accomplish these tasks via a secure location on a web site according to the present disclosure. Support personnel will assemble and create the briefing books on a daily basis, and should be allowed to preview the content as if they were an executive, to ensure that users are seeing relevant and streamlined content.

Aspects of the present disclosure provide reliable delivery of content and robust notification in case of failure. The present disclosure provides notifications when devices are unable to be synced. This ensures that the content approved after a certain time can be successfully transferred before a (specified or pre-determined) time, so that executives can review the content before a scheduled briefing.

In an aspect of the present disclosure, a functional clone at an external location, as part of the Agency Continuity of Operations (COOP) plan, is provided. This provides for operational continuity in the event of the loss of primary server connectivity due to natural disasters or other unforeseen circumstances (e.g., war, digital attack, terrorist activity).

In an aspect of the present disclosure, briefing content and related access data, including support system data (such as search indices and audit logs) may be stored or otherwise archived indefinitely. Storage database (including report databases, access databases, credential databases, and the like) storage space may span a mix of hardware types based on storage and performance requirements. For example, SQL Server and FAST Search Server (both available from Microsoft Corporation of Redmond, WA) storage are tuned for a high number of write operations per second, whereas media storage may be optimized for reading.

In an aspect of the present disclosure, viewing and annotation are designed to work on any tablet computing device executing the Microsoft Windows° 8 operating system such as the Dell° Latitude ST™ tablet (available from Dell, Inc. of round Rock, Tex.). Such devices may be manufactured in the United States and transported to agencies under controlled conditions. In an aspect, portions of such devices are assembled and configured to carry out aspects of the present disclosure. The portions are provided to a user agency (e.g., the CIA). The user agency conducts final assembly, thereby ensuring security and confirming the devices comply with necessary requirements. In an aspect of the present disclosure, a timing process is resident on the tablet computing device to automatically erase all data on the tablet when the tablet is not connected to a secure data source or docking station for a pre-determined period of time.

In an aspect of the present disclosure, security requirements identified by relevant Agency Certification and Accreditation (C&A) process are implemented.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system 100 for facilitating creation and distribution of a secure brief, according to an aspect of the present disclosure.

FIGS. 2A & B are block diagrams of exemplary portions of an infrastructure suitable for implementing aspects of the present disclosure.

FIG. 3 is a flowchart of a process for facilitating the creation and accessing of a secure brief, according to an aspect of the present disclosure.

FIG. 4 is a flowchart of a process for uploading a secure brief index to a mobile computing device, according to an aspect of the present disclosure.

FIG. 5 is a block diagram of an example computing system useful for implementing the present disclosure.

### DETAILED DESCRIPTION

The present disclosure provides systems, methods and computer program products for facilitating the creation and dissemination of secure briefing documents.

Aspects of the present disclosure may be utilized to create, update, annotate, share, and archive secure brief. Mobile computing devices, such as tablet computers, may be utilized to present secure briefs to authorized individuals. A secure brief is an electronic, updatable version of executive briefings, such as the United States President's Presidential Daily Briefing book. A secure brief comprises at least one portion of a report (e.g., an intelligence report, economic report, news story, financial analysis, and the like) suitable for consumption by a specified executive. Each portion presented contains controlled information which is presented at a content detail level chosen by secure brief preparers such as editors and publishers. Further information is presented only if the executive has the appropriate security clearance (e.g., need to know, secret, top secret). The secure brief may contain text, images, video, audio, and other information reproducible by electronic devices. Information may be annotated and edited by a receiving executive. The executive may utilize the secure brief environment to assign tasks and communicate with individuals within an organization. Reports and other information may be interlinked, hyperlinked, and otherwise digitally annotated and interrelated.

The secure brief is presented to the executive via a mobile computing device, such as a tablet computer. The tablet may be isolated from network connections outside of infrastructure which creates and distributes the secure brief, thereby reducing the opportunity for outside cyber-attack and maintaining confidentiality and integrity of data. The tablet computer may be updated via physical docking with a dataport or over the air secure transmissions.

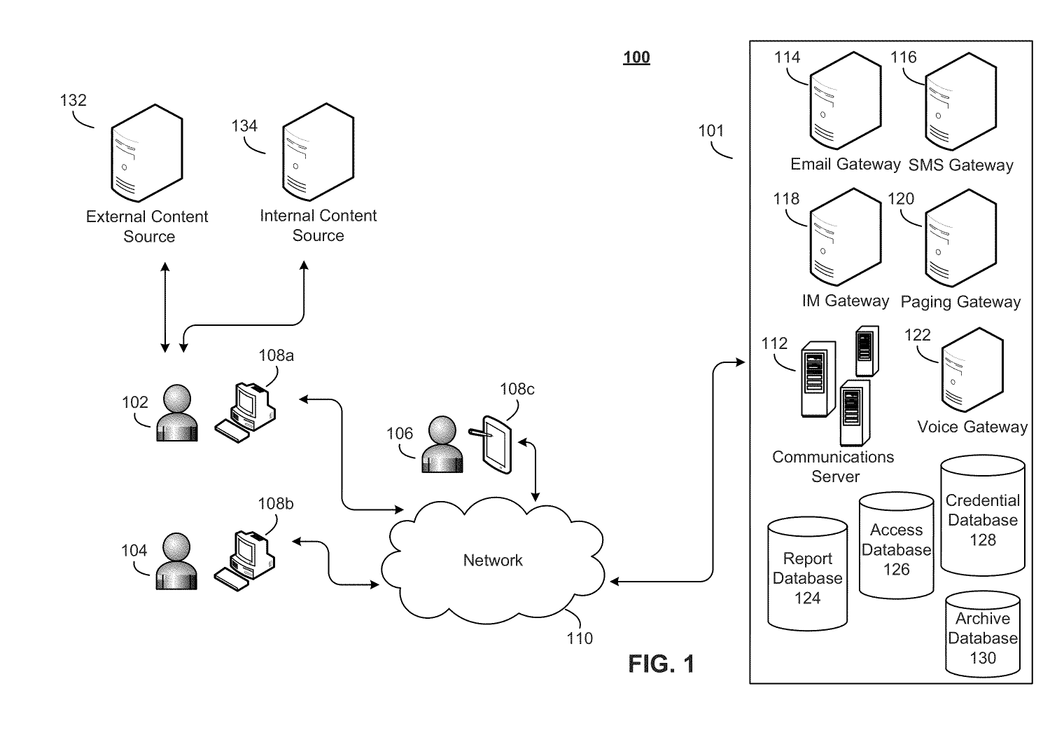

Referring now to FIG. 1, a block diagram of an exemplary system 100 for facilitating creation and distribution of a secure brief, according to an aspect of the present disclosure, is shown.

Network-enabled device communication system 100 includes one or more editors 102, one or more publishers 104 and one or more executives 106 accessing—via a computing device 108 (shown as respective computing devices 108a-c in FIG. 1) and a network 110, such as the global, public Internet—an application service provider's network-enabled infrastructure 101. In various aspects, infrastructure 101 is a cloud-based, Internet-enabled infrastructure. In various aspects, computing device 106 may be configured as: a desktop computer 108a,b; a laptop computer; a Personal Digital Assistant (PDA) or mobile telephone; a tablet or mobile computer 108c; any commercially-available intelligent communications device; or the like. System 100 may further comprise printing devices such as inkjet, thermal, or laser printers (not shown in FIG. 1). In an aspect, a single individual may serve as both editor 102 and publisher 104.

Editor 102 may identify, review, and incorporate published reports into a secure brief for consumption by executive 106. Editor 102 may read the report and any related material and contact the author with questions and clarifications necessary to ensure that executive 106 has the information needed. Editors 102 perform one or more of the following tasks: reformatting and moving content between portions of infrastructure 101, external content sources 132, and internal content sources 134 in order to may it available for use; submitting draft reports to publisher 104; determining briefing level information for each report; assigning security levels to information contained therein; editing; proof reading; redacting; and security trimming.

Publishers 104 perform one or more of the following tasks: assembling various reports; ordering the reports; approving formatted drafts of reports for inclusion in a secure brief; determine which executives 106 have the clearance and/or need-to-know to see each report and cross referencing a report with other information (e.g., biographical, geographic, financial, and the like).

Executives 106 are individual consumers of the secure briefs prepared in accordance with the present disclosure. Executives 106 are individuals who have previously consumed all or portions of physical briefing books such as executives, agency heads, directors, executive team members, agency staff, White House staff, and the like. Executives may also be individuals with field missions that require secure wireless synchronization of mission data to the tablet device.

As shown in FIG. 1, in an aspect of the present disclosure, an application service provider's communications infrastructure 101 may include one or more communications servers 112, an email gateway 114, an SMS gateway 116, an Instant Message (IM) gateway 118, a paging gateway 120, a voice gateway 122, a report database 124, an access database 126, a credential database 128, and an archive database 130. System 100 may further comprise one or more external content sources 132 and one or more internal content sources 134.

Report database 124 may be configured to store reports comprising controlled information. Such reports may be military reports, intelligence reports, top secret briefings, and the like. In another aspect, such reports may be contracts, research and development plans, competitive intelligence about corporate competition, and the like. Such reports may comprise test, audio, images, video, or any other digitally-accessible information. Access database 126 may be configured to track and store access to infrastructure 101, computing devices 108, or other portions of system 100. Credential database 128 may be configured to contain records of authorized individuals and authorized viewers. Authorized individuals/viewers include, but are not limited to, editors 102, publishers 104, and executives 106. Such records may include authorization credential (e.g., passwords, biometric data, and the like). Archive database 130 may be configured to periodically store information contained in report database 124, access database 126, credential database 128, computing devices 108, and the like, thereby serving as long term storage.

As will be appreciated by those skilled in the relevant art(s) after reading the description herein, in such an aspect, an application service provider—an individual person, business, or other entity—may allow access to infrastructure 101 via one or more World-Wide Web (WWW) sites or other portals via network 110. Thus, system 100 is scalable such that multiple editors 102, publishers 104, and executives 106 may utilize it to facilitate creation, distribution, and access to secure briefs via computing devices 108.

As will also be appreciated by those skilled in the relevant art(s), in an aspect, various screens (e.g., login, admin, account, information, resource, logout, payment, coupon print editing, coupon promotion editing, coupon campaign editing, registration, printing, communications, and the like) would be generated by server 112 in response to input from editors 102, publishers 104, and executives 106 over network 110. That is, in such an aspect, server 112 is a typical web server running a server application at a website which sends out webpages in response to Hypertext Transfer Protocol (HTTP) or Hypertext Transfer Protocol Secured (HTTPS) requests from remote browsers on various computing devices 108 being used by various editors 102, publishers 104, and executives 106. Thus, server 112 is able to provide a GUI to editors 102, publishers 104, and executives 106 of system 100 in the form of webpages. These webpages are sent to the creator's and consumer's PC, laptop, mobile device, PDA or the like device 108, and would result in the GUI being displayed.

As will be appreciated by those skilled in the relevant art(s) after reading the description herein, alternate aspects of the present disclosure may include providing a tool for facilitating creation, distribution, and access to secure briefs via computing devices 108 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where editors 102, publishers 104, and executives 106 are all personnel/employees of the same entity, the present disclosure may be implemented as a stand-alone system, rather than as a web service (i.e., Application Service Provider (ASP) model utilized by various users from different entities).

As will also be appreciated by those skilled in the relevant art(s) after reading the description herein, alternate aspects of the present disclosure may include providing the tools for facilitating the creation, distribution, and access to secure briefs via computing devices 108 via a browser pre-installed with an applet or a browser with a separately downloaded applet on such devices 108. That is, as will also be apparent to one skilled in the relevant art(s) after reading the description herein, the applet that facilitates the present disclosure, may be part of the “standard” browser that ships with computing device 108 or may be later added to an existing browser as part of an “add-on” or “plug-in.”

In an aspect, the infrastructure includes redundant hardware and servers at the data, application, and display tiers to ensure availability in the case of a server failure as well as load balance requests from web users and tablet devices.

In an aspect, infrastructure 101 via, for example, a SharePoint® application (available from Microsoft Corporation of Redmond, Wash.), is responsible for managing access to reports, secure briefs, and other data via network 110 for various users via publishing workflow features. The SharePoint application monitors the synchronization of mobile computing devices 108 and presents reports for publishers 104. Notifications that new secure briefs reports are available as well as warnings for tablet devices that have not been recently synchronized are also sent from the SharePoint application. In such an aspect, a Microsoft Windows® Presentation Foundation (WPF) application (available from Microsoft Corporation of Redmond, Wash.) on the tablet computing device 108 generates status indicators on the device for users to monitor synchronization status at a glance.

In an aspect, twenty to twenty-five executives 106 access infrastructure 101 via mobile computing devices 108. Each mobile computing device 108 is assigned to an individual executive 106 and accessible within a secured area, during a time window (e.g., within 24 hours of docking), if and only if executive 106 provides the appropriate authorization credential. Executive 106 may view and annotate reports and other content within the secure brief via mobile computing device 108. Other executives 108 may access the secure brief via a secure web portal accessible for a desktop computing device 106 connected to network 110.

In an aspect, a single mobile computing device 108 is assigned to an individual executive 106. The executive's support staff may via the update status of the secure brief on such mobile computing device 108 without accessing additional information contained therein. A director executive 108 or briefer executive may use computing device 108, including a tablet, to facilitate or attend a briefing based on secure brief distributed via the present disclosure.

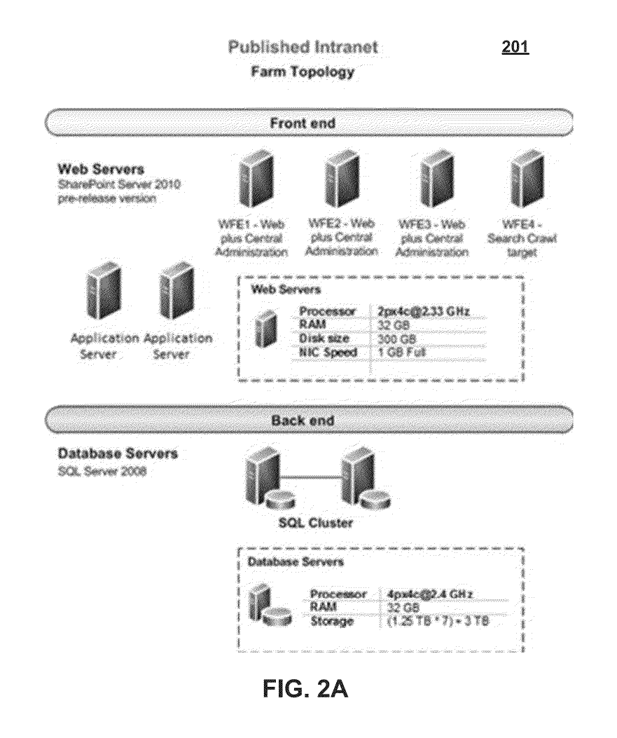

FIGS. 2A & B represent exemplary portions 201, 203 of infrastructure 101 suitable for implementing aspects of the present disclosure. Four Web Front Ends (WFEs) are included to provide redundancy and performance. The server marked “search crawl target” is used to provide an interface for the search crawler so that crawling has less of an impact on overall system performance.

With respect to virtualization, the SQL Cluster and SharePoint Search index servers may be hosted on physical hardware (not virtualized), thereby enhancing performance and security. In alternate aspects, other servers and aspects of system 100 may be virtualized.

In an aspect of the present disclosure, a SharePoint-based back end system is implemented. SharePoint data is stored in SQL Server. As querying a database server for large files can be difficult, Remote Blob Storage (RBS) is enabled, which stores media files to an external location while facilitating queries through SQL Server.

Security for reports, secure briefs, data and other files may be implemented using Access Control Lists.

In an aspect, users may access a SharePoint site with one or more custom web parts or pages to access secure briefs.

Notifications, reliable report delivery, and business process flow between permission assignment, prioritization and finalization of content, approval, and any subsequent edits may be facilitated within system 100.

In an aspect, entities utilizing system 100 (e.g., government agencies) may implement one or more records management division mandates in order to capture and preserve official records. Such records may be stored in archive database 130.

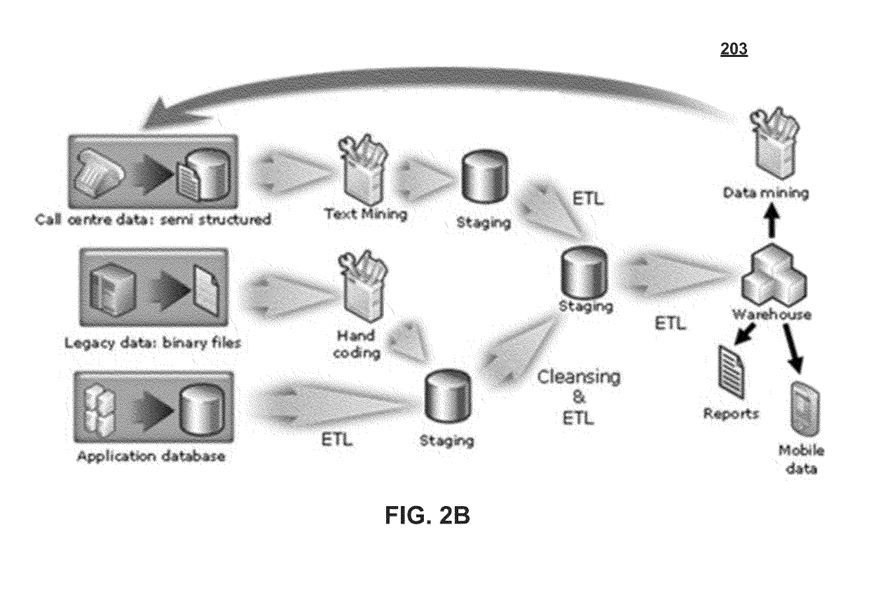

Referring to FIG. 3 a flowchart of a process 300 for facilitating the creation and accessing of a secure brief, according to an aspect of the present disclosure, is shown.

Process 300, which may execute within system 100 and facilitate creation, distribution and utilization of one or more secure briefs, begins at step 302 with control passing immediately to step 304.

At step 304, one or more reports are received. In an aspect, editor 102 uploads a report from external content source 132 or internal content source 134. Editor 102 may proofread, collate, edit, or otherwise process the report before uploading the report to infrastructure 101.

At step 306, infrastructure 101 stores the report received at step 304. Report may be stored in report database 124.

At step 308, security information for each of the reports received in step 304 is received by infrastructure 101. In an aspect, editor 104 provides security information after reviewing and approving each report. Security information restricts access to the report based on viewer security clearance level, viewer's need to know, and other factors apparent to those skilled in the relevant art(s) after reading the description herein.

At step 310, briefing level information for each of the reports received in step 304 is received. Briefing level information indicates how much of each report should be shown to each executive 106. For example, a high level executive may desire or only have time to read and process the headlines or abstracts of a variety of reports, while a lower level analyst has time to read and process the entirety of such reports. Providing briefing level information enables infrastructure 101 to provide customized reports to each executive 106 via computing device 108 in a tailored way that enables maximum information retention and dissemination. Briefing level information may be provided on an individual basis, a position level basis, or based on other criteria. Briefing level information may be provided by editors 102, publishers 104, or other individuals.

At step 312, a request for a secure brief is received. Executive 106 provides an authorization credential to mobile computing device 108 which is processed. Processing may occur at mobile computing device 108 or within infrastructure 101. If the brief request is approved, step 314 executes. In an aspect, the brief request is approved only if mobile computing device 108 has been synced with infrastructure 101 within a specified time window. In another aspect, the brief request is approved only if computing device 108 is within an authorized area, such as a secure facility.

At step 314, a secure brief is presented to executive via computing device 108. The secure brief is presented to executive 106. The secure brief comprises portions of each of the plurality of reports based on the received security information, the received briefing level information and the received authorization credential. The secure brief may be displayed for a specified time, until executive 106 locks computing device 108, until computing device 108 detects executive 106 is no longer examining the secure brief, or until another event apparent to those having skill in the relevant art(s) after reading the description herein.

Process 300 terminates at step 316.

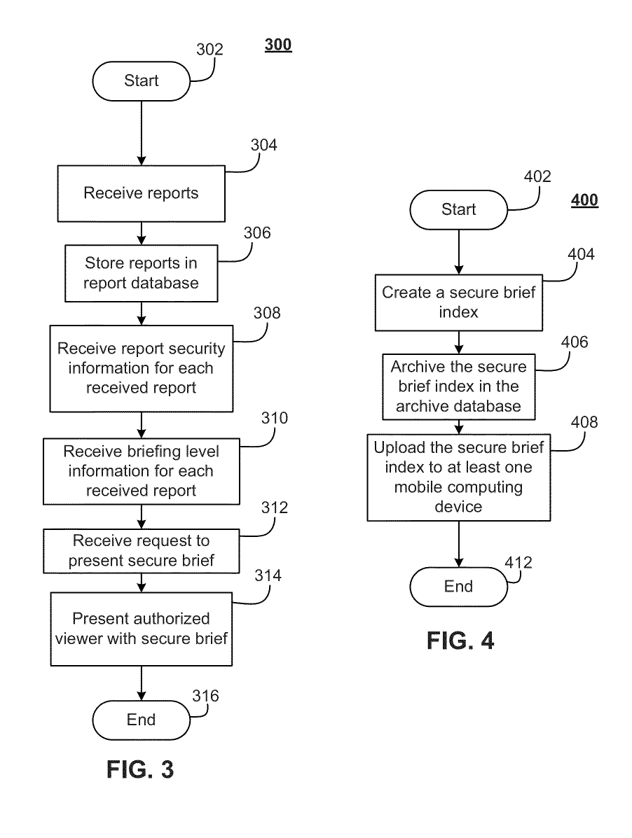

Referring to FIG. 4, a flowchart of a process 400 for uploading a secure brief index to computing device 108, according to an aspect of the present disclosure, is shown.

Process 400, which may execute within system 100 and facilitate distribution of one or more secure briefs via uploading a secure brief index to computing device 108, begins at step 402 with control passing immediately to step 404.

At step 404, a secure brief index suitable for loading onto mobile computing device 108 is created. The secure brief index comprises reports for the associated secure brief, security information associated with such reports, and briefing level information associated with the reports and executives 106 who will be presented with the associated secure brief.

At step 406, the secure brief index created at step 404 is saved at archive database 130.

At step 408, the secure brief index created at step 404 is uploaded to at least one computing device 108. In an aspect, the secure brief index is uploaded via network 110 by physical connection. In another aspect, upload occurs via wireless connection.

Process 400 terminates at step 410.

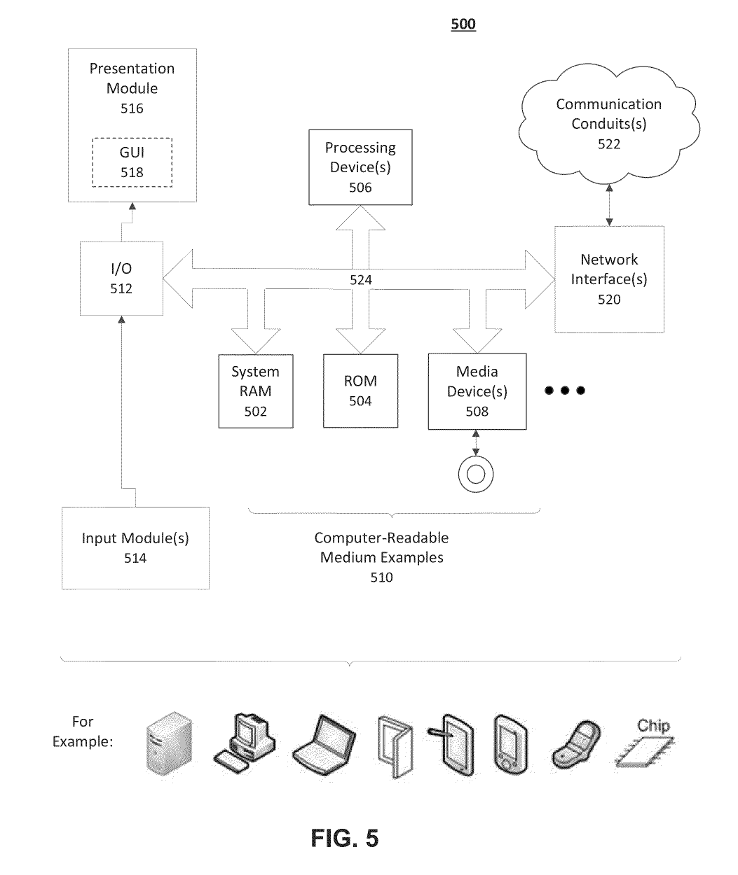

Referring to FIG. 5, a block diagram illustrating an exemplary computer system useful for implementing an aspect of the present disclosure, is shown.

FIG. 5 sets forth an illustrative computer system that may be used to implement computing functionality 500, which in all cases represents one or more physical and tangible processing mechanisms.

Computing functionality 500 may comprise volatile and non-volatile memory, such as RAM 502 and ROM 504, as well as one or more processing devices 506 (e.g., one or more central processing units (CPUs), one or more graphical processing units (GPUs), and the like). Computing functionality 500 also optionally comprises various media devices 508, such as a hard disk module, an optical disk module, and so forth. Computing functionality 500 may perform various operations identified above when the processing device(s) 506 execute(s) instructions that are maintained by memory (e.g. RAM 502, ROM 504, and the like).

More generally, instructions and other information may be stored on any computer readable medium 510, including, but not limited to, static memory storage devices, magnetic storage devices, and optical storage devices. The term “computer readable medium” also encompasses plural storage devices. In all cases, computer readable medium 510 represents some form of physical and tangible entity. By way of example, and not limitation, computer readable medium 510 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 502, ROM 504, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 500 may also comprise an input/output module 512 for receiving various inputs (via input modules 514), and for providing various outputs (via one or more output modules). One particular output module mechanism may be a presentation module 516 and an associated GUI 518. Computing functionality 500 may also include one or more network interfaces 520 for exchanging data with other devices via one or more communication conduits 522. In some embodiments, one or more communication buses 524 communicatively couple the above-described components together.

Communication conduit(s) 522 may be implemented in any manner (e.g., by a local area network, a wide area network (e.g., the Internet), and the like, or any combination thereof). Communication conduit(s) 522 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, and the like).

While various aspects of the present disclosure have been described herein, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

What is claimed is:

1. A computer-implemented method for facilitating the distribution of a secure brief, the method comprising the steps of:
(a) receiving a plurality of reports, each of the plurality of reports comprising controlled information;
(b) storing each of the plurality of reports in a report database;
(c) receiving report security information for each of the plurality of reports, the report security information restricting access based on a viewer security clearance level;
(d) receiving briefing level information for each of the plurality of reports, the briefing level information indicating a content detail level for a plurality of viewers;
(e) receiving, at a mobile computing device, a secure brief request comprising an authorization credential from an authorized viewer; and
(f) presenting, via the mobile computing device, the authorized viewer with a secure brief, the secure brief comprising portions of each of the plurality of reports based on the received security information, the received briefing level information and the received authorization credential.

2. The method of claim 1, further comprising the steps of:
(g) creating a secure brief index comprising:
(i) the received plurality of reports;
(ii) the received security information; and
(iii) the received briefing level information; and
(h) archiving the secure brief index in an archive database.

3. The method of claim 2, further comprising the step of:
(i) uploading the secure brief index to the mobile computing device.

4. The method of claim 1, further comprising the steps of:
(g) receiving, at a mobile computing device, a second secure brief request comprising a second authorization credential from a second authorized viewer; and
(h) presenting, via the mobile computing device, the second authorized viewer with a second secure brief, the second secure brief comprising portions of each of the plurality of reports based on the received security information, the received briefing level information and the received second authorization credential.

5. The method of claim 1, further comprising the step of:
(g) receiving a secure brief creation window specifying a briefing time period during which the secure brief may be presented to the authorized viewer;
wherein presenting step (f) is carried out only if the secure brief request is received at the mobile computing device during the briefing time period.

6. The method of claim 1, wherein presenting step (f) is carried out only if the mobile computing device is within an authorized area.

7. The method of claim 1, wherein the controlled information comprises at least one of: text; images; video; and audio.

8. The method of claim 1, wherein the received report security information designates each of the plurality of reports one of: confidential; secret; and top secret.

9. One or more computer storage media having stored thereon multiple instructions that facilitate the distribution of a secure brief by, when executed by one or more processors of a computing device, causing the one or more processors to:
(a) receive a plurality of reports, each of the plurality of reports comprising controlled information;
(b) store each of the plurality of reports in a report database;
(c) receive report security information for each of the plurality of reports, the report security information restricting access based on a viewer security clearance level;
(d) receive briefing level information for each of the plurality of reports, the briefing level information indicating a content detail level for a plurality of viewers;
(e) receive, at a mobile computing device, a secure brief request comprising an authorization credential from an authorized viewer; and
(f) present, via the mobile computing device, the authorized viewer with a secure brief, the secure brief comprising portions of each of the plurality of reports based on the received security information, the received briefing level information and the received authorization credential.

10. One or more computer storage media as recited in claim 9, wherein the multiple instructions further cause one or more processors to:
(g) create a secure brief index comprising:
(i) the received plurality of reports;
(ii) the received security information; and
(iii) the received briefing level information; and
(h) archive the secure brief index in an archive database.

11. One or more computer storage media as recited in claim 10, wherein the multiple instructions further cause one or more processors to:
(i) upload the plurality of reports to the mobile computing device; and
(j) upload the secure brief index to the mobile computing device.

12. One or more computer storage media as recited in claim 9, wherein the multiple instructions further cause one or more processors to:
(g) receive, at a mobile computing device, a second secure brief request comprising a second authorization credential from a second authorized viewer; and
(h) present, via the mobile computing device, the second authorized viewer with a second secure brief, the second secure brief comprising portions of each of the plurality of reports based on the received security information, the received briefing level information and the received second authorization credential.

13. One or more computer storage media as recited in claim 9, wherein the multiple instructions further cause one or more processors to:
(g) receive a secure brief creation window specifying a briefing time period during which the secure brief may be presented to the authorized viewer;
wherein presentation step (f) is carried out only if the secure brief request is received at the mobile computing device during the briefing time period.

14. One or more computer storage media as recited in claim 9, wherein presentation step (f) is carried out only if the mobile computing device is within an authorized area.

15. One or more computer storage media as recited in claim 9, wherein the controlled information comprises at least one of: text; images; video; and audio.

16. One or more computer storage media as recited in claim 9, wherein the received report security information designates each of the plurality of reports one of: confidential; secret; and top secret.

17. A system for facilitating presenting an authorized viewer with a secure brief, comprising:
(a) at least one communications server capable of communicating, via a communications network, with at least one mobile computing device, the at least one mobile computing device configured to communicate with at least one authorized viewer;
(b) a report database, communicatively coupled to the at least one communications service via the communications network;
(c) an access database, communicatively coupled to the at least one communications service via the communications network;
(d) at least one application server, communicatively coupled to the at least one communications server via the communications network, the at least one application server comprising:
(i) a report collection service capable of receiving the plurality of reports, each of the plurality of reports comprising controlled information, and capable of storing each of the plurality of reports in the report database;
(ii) an index creation service capable of receiving report security information for each of the plurality of reports, the report security information restricting access based on a viewer security clearance level, capable of receiving briefing level information for each of the plurality of reports, the briefing level information indicating a content detail level for a plurality of viewers, and capable of creating a secure brief index comprising:
(a) the received plurality of reports;
(b) the received security information; and
(c) the received briefing level information; and
(iii) a publishing service capable of uploading the secure brief index created by the index creation service to the at least one mobile computing device; and
(e) the at least one mobile computing device, communicatively couplable to the at least one communications service via the communications network, the at least one mobile computing device comprising:
(i) a secure brief presentation service, capable of presenting the at least one authorized viewer with a secure brief, the secure brief comprising portions of each of the plurality of reports based on the secure brief index uploaded to the at least one mobile computing device; and
(ii) an authorization service capable of receiving a secure brief request comprising an authorization credential from the at least one authorized viewer.

18. The system of claim 17, further comprising:
(f) a credential database, communicatively coupled to the at least one communications service via the communications network, comprising at least one approved credential;
wherein the authorization service is capable of comparing the received authorization credential with the at least one approved credential; and
wherein the at least one authorized viewer will not be presented with the secure brief unless the received authorization credential matches the at least one approved credential.

19. The system of claim 17, wherein the secure brief presentation service is not capable of presenting the secure brief unless the secure brief request is received by the at least one mobile computing device during a briefing time period.

20. The system of claim 17, wherein the secure brief presentation service is not capable of presenting the secure brief unless the at least one mobile computing device is within an authorized area.

21. The system of claim 17, wherein the controlled information comprises at least one of: text; images; video; and audio.

22. The system of claim 17, wherein the received report security information designates each of the plurality of reports one of: confidential; secret; and top secret.
